(19) United States
(12) Patent Application Publication
(10) Pub. No.: US 2024/0043271 A1
(43) Pub. Date: Feb. 8, 2024

(54) ENERGY PRODUCTION DEVICE COMPRISING A DIHYDROGEN PRODUCTION UNIT; METHOD USIING THIS DEVICE

(71) Applicant: SAKOWIN, Frejus (FR)

(72) Inventors: Gerard GATT, Frejus (FR); Marilena RADOIU, Frejus (FR); Yves GEORGE, Frejus (FR); Giovanni TRIMBOLI, Frejus (FR)

(73) Assignee: SAKOWIN, Frejus (FR)

(21) Appl. No.: 18/255,939

(22) PCT Filed: Dec. 9, 2021
(86) PCT No.: PCT/FR2021/052251

§ 371 Date: Jun. 5, 2023

(30) Foreign Application Priority Data
Dec. 17, 2020 (FR) 2013573

(51) Int. Cl. C01B 3/24; C01B 3/50; H05H 1/46

(52) U.S. Cl. CPC C01B 3/24; C01B 3/50; H05H 1/4622; C01B 2203/0272; C01B 2203/0861; C01B 2203/1235; C01B 2203/066; C01B 2203/169; C01B 2203/84; C01B 2203/049

(57) ABSTRACT

An energy production device may include: a supply device for hydrocarbon gas; energy converter configured to convert the energy supplied by the H₂ into electrical, thermal, and/or mechanical energy; H₂ producer fluidically between the supply device and the energy converter; the H₂ producer including a plasmalysis reactor configured to generate plasmalysis of the hydrocarbon gas so as to produce at least one dihydrogen directed towards the energy converter; a controller configured to generate a control instruction for the H₂ producer with information on H₂ present in a H₂ distribution area arranged fluidically between the plasmalysis reactor and the energy converter, the H₂ distribution area including a storage assembly at the plasmalysis reactor outlet and hydraulically connected to the plasmalysis reactor and energy converter, the storage assembly including a compression device, storage tank, and expander, the compression device being positioned to transfer H₂ exiting the plasmalysis reactor into the storage tank.

The present invention relates to the field of energy production, and more particularly to energy production involving production of dihydrogen.

Dihydrogen is considered to be an energy of the future, with multiple applications in transportation, industrial production, and heating. Thus, it is in particular envisaged to widely use dihydrogen as fuel for cars and other transportation means.

Furthermore, it is known to have heating facilities or other industrial installations that use dihydrogen as a combustion gas. In this context, the production of large amounts of dihydrogen is mainly based on two different processes. A first process uses steam reforming, which consists of reacting a hydrocarbon, mainly methane, with water. The formation of dihydrogen is accompanied by a release of carbon dioxide which is one of the most common greenhouse gases. When this solution is coupled with a carbon dioxide capture mechanism, only 70% to 90% of the carbon dioxide thus released are sequestered to avoid their release into the atmosphere. Finally, the conversion energy yield is limited to 82%, in particular due to the fact that steam reforming requires an energy supply. Such a yield is even more degraded by the implementation of the carbon dioxide capture mechanism.

A second method uses water electrolysis, which consists of breaking down the water into dioxygen and dihydrogen by means of an electric current. The electric current is supplied by an external energy source which is, to date, even more carbon-heavy in many countries, that is to say producing in particular carbon dioxide. Water electrolysis, the main method for producing dihydrogen with steam reforming, uses more electricity than the dihydrogen produces during its use, for example in a fuel cell.

The dihydrogen produced in industrial sites is generally conveyed, for example by truck, from the production unit to the distribution or consumption site. However, the transportation logistics are complex and expensive to implement.

In the case of heating installation using dihydrogen, it is also known to equip the site of the heating plant with electrolyzers that make it possible to produce dihydrogen on-site which will then be used by the heating facility. However, the production of dihydrogen by electrolysis is not yet optimal due to the investment and production costs, related to production capacity.

The present invention falls within this context and aims to propose an energy production device which uses dihydrogen for this production of energy and which integrates a production unit for this dihydrogen which is economical and ecological and whose operation can be adjusted to the energy demand.

The present invention proposes a device for producing energy, comprising a device for supplying hydrocarbon gas, an energy conversion unit, a dihydrogen production unit arranged fluidically between the device for supplying hydrocarbon gas and the energy conversion unit, the energy conversion unit being configured to convert the energy supplied by the dihydrogen into electrical, thermal and/or mechanical energy, the dihydrogen production unit comprising at least one microwave plasma plasmalysis reactor configured to generate plasmalysis of the hydrocarbon gas in such a way as to produce at least one dihydrogen directed towards the energy conversion unit, the energy production device comprising a control module configured to generate a control instruction for the dihydrogen production unit according to a piece of information relating to the dihydrogen present in a dihydrogen distribution area arranged fluidically between the plasmalysis reactor and the energy conversion unit, the dihydrogen distribution area, arranged fluidically between the plasmalysis reactor and the energy conversion unit, comprising a storage assembly arranged exiting the plasmalysis reactor and hydraulically connected to the plasmalysis reactor and to the energy conversion unit, said storage assembly comprising at least a compression device, a storage tank, and an expander, the compression device being positioned to transfer the dihydrogen exiting the plasmalysis reactor into the storage tank.

According to the invention, the piece of information relating to the dihydrogen may in particular consist of dihydrogen pressure information and/or dihydrogen flow rate information.

This information is in particular detected in a dihydrogen distribution area, which may also consist on the one hand in a dihydrogen circulation conduit alone, and correctly sized to bring the dihydrogen to a flow rate that is sufficiently high not to block the operation of the downstream energy conversion unit, or on the other hand, and as will be detailed below, in a pipe equipped with an associated storage means, coupled, where appropriate, to means for regulating dihydrogen pressure.

The dihydrogen production unit is configured to implement a plasmalysis of the hydrocarbon gas, which is a decomposition reaction of the hydrocarbon gas giving rise to dihydrogen gas (H2_{(g)}) and solid carbon (C₍ₛ₎) by virtue of a plasma generated by microwave radiation, and the energy production device according to the invention is configured to control the operation of the dihydrogen production unit according to the needs of the energy production unit. The invention thus makes it possible to adopt an operating mode that is suitable, and therefore one that is simultaneously economical, low-energy-consuming, and effective, to the type and size of the energy production unit associated with the dihydrogen production unit.

One advantage of the invention is that it is environmentally friendly by implementing hydrocarbon gas plasmalysis. The dihydrogen production unit makes it possible to produce dihydrogen in a decarbonized manner, that is to say without carbon dioxide emission, unlike the other dihydrogen production technologies, such as steam reforming, which releases carbon dioxide and can capture only 70% to 90% of the carbon dioxide emitted, or the electrolysis of water which in many countries is connected in part to an electricity production system that produces carbon dioxide.

The implementation of plasmalysis makes it possible in particular to produce dihydrogen that is much less energy-consuming than production of dihydrogen by electrolysis. It also makes it possible to associate with the production of dihydrogen means for controlling the operation of the production unit, obtaining dihydrogen by plasmalysis, involving the generating of microwaves, being more particularly suitable for modulation of the operation of the production unit.

More particularly, the microwave power absorbed by the plasma can be easily adjusted to the need, since the extinction, ignition or modulation of power of the microwave generator is very rapid, on the order of a fraction of a second, without there being inertia from the device.

According to an optional feature of the invention, the plasmalysis is carried out at a pressure substantially equal to atmospheric pressure, and advantageously at a value greater than atmospheric pressure, as a function of the flow rate of dihydrogen necessary for the application. The choice of a pressure greater than atmospheric pressure makes it possible to ensure the flow of hydrocarbon gas arriving under overpressure via the supply device, without it being necessary to provide other components on an inlet circuit than a supply cut-off valve. Furthermore, the choice of such pressure makes it possible to avoid an oxygen inlet inside the plasmalysis reactor in the event of loss of sealing.

According to an optional feature of the invention, the control instruction of the dihydrogen production unit consists of at least one instruction for controlling the hydrocarbon gas inlet via the supply device. More particularly, the dihydrogen production unit can comprise a controllable valve arranged on a pipe for connecting to the hydrocarbon gas supply device allowing the circulation of this hydrocarbon only in the direction of the plasmalysis reactor, and the control module is configured to control the valve, whether in on/off operation or in a modulation of the flow rate. In this way, the amount of hydrocarbon gas arriving in the plasmalysis reactor and the amount of dihydrogen produced by the dihydrogen production unit are influenced, independently of the operating parameters of the plasmalysis reactor.

According to an optional feature of the invention, the control instruction of the dihydrogen production unit consists of at least one control instruction for the plasmalysis reactor. In this way, the amount of dihydrogen produced by the production unit is influenced by adjusting the operating parameters of the plasmalysis reactor, though without modifying the flow of hydrocarbon gas directed to the production unit.

It should be noted that the control module can just equally well generate one or more control instructions specifically intended for the plasmalysis reactor, or generate a single control instruction specifically intended for the supply device, and/or generate control instructions both for the supply device and for the plasmalysis reactor, in order to obtain optimal operation of the energy production device.

According to an optional feature of the invention, the hydrocarbon gas is chosen from the group comprising methane, propane, butane and its isomers, natural gas, biomethane and mixtures thereof.

According to an optional feature of the invention, the hydrocarbon gas supply device is a gas hydrocarbon transport and distribution network and/or at least one storage tank constituting the dihydrogen production unit. The transport network makes it possible to convey the hydrocarbon gas from gas terminals. The transport network is thus for example a pipeline. The storage tank can be supplied by tanker trucks or be replaced when it is empty.

According to an optional feature of the invention, the plasmalysis reactor comprises at least one microwave radiation generator, a microwave transmission guide configured to guide the microwave radiation from the microwave radiation generator to a microwave radiation cavity.

A resonant microwave radiation cavity, also called a resonator, is a hollow space inside a metal block in which microwave radiation enters into resonance. The resonant microwave radiation cavity allows very effective coupling of the microwave radiation with the hydrocarbon gas so as to form the plasma.

It should be understood here, as well as in the following, by resonance that the microwave radiation is 100% reflected by at least one wall of the block delimiting the microwave radiation cavity, when there is no plasma present in the microwave radiation cavity.

The plasmalysis reactor may also comprise a microwave radiation isolator configured to prevent microwave radiation not absorbed by the plasma from returning to the microwave radiation generator

The microwave radiation isolator may be arranged between the microwave radiation generator and the microwave transmission guide.

According to an optional feature of the invention, the pressure within at least part of the dihydrogen production unit, in particular within the microwave radiation cavity, is greater than or equal to atmospheric pressure.

According to an optional feature of the invention, the microwave radiation generator is configured to provide microwave radiation having a power of between 0.1 kW and 100 kW and a frequency of between 850 MHz and 6 GHz, preferably equal to 896 MHz, 915 MHz, 922 MHz, 2.45 GHz or 5.8 GHz.

According to an optional feature of the invention, the control instruction of the plasmalysis reactor consists of a control instruction for the plasmalysis reactor.

According to an optional feature of the invention, the microwave transmission guide is a waveguide of rectangular or cylindrical section or a coaxial cable.

According to an optional feature of the invention, the plasmalysis reactor comprises a cooling device configured to cool the microwave radiation generator with water and/or air.

According to an optional feature of the invention, the plasmalysis reactor comprises a plasma ignition device comprising a retractable metal tip configured to be inserted or retracted into the microwave radiation cavity using an actuator. In other words, the ignition device is an electromechanical mechanism with an actuator which is configured to move a metal tip between a position outside the microwave radiation cavity, that is to say retracted, and a position inside the microwave radiation cavity. In position in the microwave radiation cavity, the metal tip is configured to create an electrical discharge which initiates the plasma necessary for plasmalysis.

According to an optional feature of the invention, the control instruction for the plasmalysis reactor consists of a control instruction for the ignition device.

According to various optional features of the invention, taken alone or in combination:
the plasmalysis reactor comprises a gas injection device comprising at least one head configured to generate a hydrocarbon gas flow from the supply device and arranged in the microwave radiation cavity so as to form a vortex of the hydrocarbon gas flow in the microwave radiation cavity.
the plasmalysis reactor comprises a water or/and air cooling circuit
the plasmalysis reactor is configured so that the hydrocarbon gas is the plasma gas and is the plasmalysis reagent to form the dihydrogen and the solid carbon.
the plasmalysis reactor comprises at least one nozzle configured to contain the plasma and to ensure a gradual reduction in the temperature of the products derived from plasmalysis, exiting the microwave radiation cavity.
the nozzle is composed at least partly of ceramic and/or metal, such that the nozzle can endure the temperatures induced by the plasma.
the plasmalysis reactor comprises at least one pipe arranged around the nozzle so that at least a part of the pipe delimits a thermal isolation chamber of the plasma. In other words, the pipe has a suitable shape, concentric to a part of the nozzle, and the chamber is the space between the nozzle and the pipe. Thus, the chamber makes it possible to thermally isolate the plasma.
another part of the pipe delimits a cooling chamber of at least some plasmalysis reaction products, including dihydrogen and solid carbon produced by plasmalysis. The reaction products combine the products from the plasmalysis and any hydrocarbon gas residues that was not broken down during plasmalysis.
the pipe comprises, on an internal face, a plurality of fins which extend radially from the internal face of the pipe in the direction of the center of the pipe and which are thermally coupled with the internal face of the pipe. Thus, the heat exchanges with the reaction products are improved, facilitating the solidification of the carbon. The plurality of fins may be arranged in the cooling chamber of the pipe.
the pipe may be devoid of fins and comprise a smooth inner face.
the dihydrogen production unit comprises a fluid circulation device configured to at least partly cool the pipe. Thus, the cooling of the reaction products is ensured by convective and conductive exchanges with at least one internal face of the pipe which is cooled by the circulation device when the flow of the reaction products flows to a separation device. The separation of the dihydrogen from the other reaction products is improved by this cooling. When the pipe further comprises the fins, the separation is much more effective. In this context, it is understood that the internal face of the other part of the pipe delimiting the cooling chamber is cooled by the fluid circulation device.

According to an optional feature of the invention, the dihydrogen production unit comprises filtration means so as to purify the dihydrogen produced by the plasmalysis of the other reaction products. Thus, the dihydrogen has sufficient purity to be used in a fuel cell, for example.

The dihydrogen production unit is thus designed to be efficient in terms of resources and it is operated according to a method which completely eliminates the generation of carbon dioxide. This is how the dihydrogen production unit is decarbonized. Therefore, an additional advantage of the invention lies in its ease of implementation on demanding industrial sites or on small areas, in particular because there is no need to filter or store large quantities of carbon dioxide.

According to an optional feature of the invention, the dihydrogen production unit comprises a return line configured to inject at least a portion of the reaction products of the plasmalysis into the resonant microwave radiation cavity. Thus, any hydrocarbon gas residues are systematically recycled.

According to an optional feature of the invention, the reaction products mainly comprise dihydrogen gas and solid carbon, as well as possible hydrocarbon gas residues, such as methane, which are systematically recycled via the return line to the reactor.

According to an optional feature of the invention, the dihydrogen production unit comprises a device for recovering solid carbon generated by plasmalysis. The solid carbon can in particular be recovered for industrial purposes.

According to an optional feature of the invention, the microwave radiation generator is chosen between a magnetron type generator and a semiconductor microwave generator, also called a solid-state microwave generator. In other words, the microwave radiation generator is a solid-state generator or a magnetron.

According to an optional feature of the invention, the control instruction for the dihydrogen production unit consists of at least one control instruction for the compression device.

According to an optional feature of the invention, the piece of information relating to the dihydrogen present in a dihydrogen distribution area from which the control module is configured to control the operation of the dihydrogen production unit is information relating to the dihydrogen present in the storage assembly, and in particular the storage tank.

According to an optional feature of the invention, at least two control instructions chosen from the control instruction for the compression device, the control instruction for the supply device, the control instruction for the ignition device and the control instruction for the microwave radiation generator, are sent and implemented simultaneously. In a particular embodiment, all of these control instructions are implemented simultaneously.

According to an optional feature of the invention, and in the context of an embodiment with a storage assembly present in the dihydrogen distribution area and comprising at least one compression device and a storage tank, the microwave radiation generator is either a magnetron microwave radiation generator or a solid-state microwave radiation generator. Indeed, in this context, the format of the microwave radiation generator is not very important because the storage tank has a sufficient volume to form an effective buffer effect regardless of the dihydrogen demand of the energy conversion unit, and the importance of the reactivity of the starting of the dihydrogen production unit is less fundamental than what has been mentioned above. Where appropriate, the storage assembly may comprise an expander making it possible to pressurize the dihydrogen exiting the storage tank. It should be noted that this expander could form part of the energy conversion unit and be fluidically connected in the same way to the outlet of the storage tank.

As a non-limiting example, the storage tank can have a volume for receiving dihydrogen on the order of one cubic meter (m³).

According to an optional feature of the invention, a filtration system is arranged upstream of the plasmalysis reactor. Such a filtration system is more particularly arranged between the supply device and the plasmalysis reactor, and it makes it possible in particular to purify the hydrocarbon gas intended to be injected into the microwave radiation cavity in order to improve the performance of plasmalysis.

According to an optional feature of the invention, a filtration device is arranged downstream of the plasmalysis reactor, the filtration device being configured to separate the dihydrogen from other residual gases. Such a filtration device is more particularly arranged between the plasmalysis reactor and the dihydrogen distribution area, and it in particular makes it possible to ensure a high level of dihydrogen purity intended to supply the energy conversion unit. The presence of such a filtration device is in particular advantageous when the energy conversion unit consists of a fuel cell requiring a dihydrogen with a high purity level.

According to an optional feature of the invention, the production device comprises a return pipe which extends between the filtering device and the plasmalysis reactor, in order to reinject residual gases collected in the filtering device into the reactor.

According to an optional feature of the invention, the energy conversion unit is a domestic, collective or industrial heating installation, or an industrial process heat source. The energy conversion unit is then configured to convert the energy supplied by the dihydrogen into thermal energy. Such an energy conversion unit is advantageously provided in an embodiment of the energy production device wherein the dihydrogen distribution area is at equal pressure with the plasmalysis reactor and the energy conversion unit. The amount of dihydrogen to be supplied to the energy conversion unit can then be supplied continuously, by the quantity of dihydrogen present in the dihydrogen distribution area and by the reactivity of the dihydrogen production unit.

According to an optional feature of the invention, the energy conversion unit comprises a gas turbine, or an internal combustion engine, associated with a generator. The energy conversion unit is then configured to convert the energy supplied by the dihydrogen into electrical and/or mechanical energy. Such an energy conversion unit is advantageously provided in an embodiment of the energy production device wherein the dihydrogen distribution area is equipped with a storage assembly with a compressor, the compressor allowing the storage of dihydrogen in the tank to a pressure of 900 bars. The amount of dihydrogen to be supplied to the energy conversion unit can then be supplied immediately without interruption, at the desired pressure for the gas turbine or the internal combustion engine, by using an expander forming part of the storage assembly.

According to an optional feature of the invention, the energy conversion unit comprises a fuel cell. Such an energy conversion unit is advantageously provided in one embodiment of the energy production device

wherein the dihydrogen distribution area is equipped with a storage assembly with a compressor, the compressor allowing the storage of dihydrogen in the tank to a pressure of 900 bars. Furthermore, such an energy conversion unit is advantageously provided in an embodiment of the energy production device wherein a device for filtering reaction products exiting the plasmalysis reactor makes it possible to ensure the high degree of purity of the dihydrogen produced.

Thus, according to a feature of the invention, the energy production device comprises a dihydrogen filtration member arranged fluidically between the compression device and the storage tank, said dihydrogen filtering member being configured to guarantee a purity of the dihydrogen compatible with the operation of a fuel cell.

According to an optional feature of the invention, the information relating to the dihydrogen present in the dihydrogen distribution area is obtained via a pressure gauge, said control module being configured to generate and transmit a control instruction to the dihydrogen production unit when the pressure measured by the gauge is below a threshold value.

In other words, the device according to the invention comprises a gauge capable of detecting information, for example the pressure or the flow rate of the dihydrogen, in the storage tank or a dihydrogen circulation pipe, once it is in the dihydrogen distribution area between the dihydrogen production unit and the energy conversion unit. And the pressure or flow rate value is sent to the control module so that it can compare that value to a threshold value.

The threshold value can vary depending on the demand flow of the energy conversion unit of the volume of the tank. In the case of a pressure measurement, this threshold value can in particular be 10 bars. As soon as the measured pressure is below the threshold value, the control module generates a control instruction in accordance with this situation, namely an underpressure in the significant dihydrogen distribution area indicating a demand for dihydrogen by the energy conversion unit, and the control instruction aims to start the dihydrogen production unit or to increase its efficiency.

Finally, one object of the invention is a method for operating an energy production device as previously mentioned, during which the dihydrogen production unit is controlled by the control module by modulating the production of dihydrogen according to the operation of the energy conversion unit.

According to an optional feature of the invention, the modulation of the production of dihydrogen is carried out in binary mode, the plasmalysis reactor being started only when the information relating to the dihydrogen present in the dihydrogen distribution area has an outgoing value from a predefined value range. For example, it is understood that the plasmalysis reactor is started up when the pressure detected in the dihydrogen distribution area is below a threshold value, for example 10 bars. In other words, this is an operation of the start-and-stop type, wherein the dihydrogen production unit is started on demand, once the dihydrogen requirement of the energy conversion unit is identified.

According to an optional feature of the invention, the modulation of the production of dihydrogen is carried out by adjusting the flow rate and/or the pressure of the hydrocarbon gas entering the dihydrogen production unit and/or by adjusting the operating power of the dihydrogen production unit. This ensures a responsive operation of the dihydrogen production unit, albeit while reducing the energy necessary to operate this production unit. By operating power of the dihydrogen production unit, it should be understood that the aim is to modulate the operation of at least one component of the dihydrogen production unit when this modulation has an effect on the quantity of dihydrogen provided in a given time by the dihydrogen production unit.

According to an optional feature of the invention, the microwave radiation generator is configured to provide microwave radiation having a power of between 0.1 kW and 100 kW and a frequency of between 850 MHz and 6 GHz, preferably equal to 896 MHz, 915 MHz, 922 MHz, 2.45 GHz or 5.8 GHz.

Other features and advantages of the invention will appear both from the description which follows and from several exemplary embodiments, which are given for illustrative purposes and without limitation with reference to the appended schematic drawings, in which:

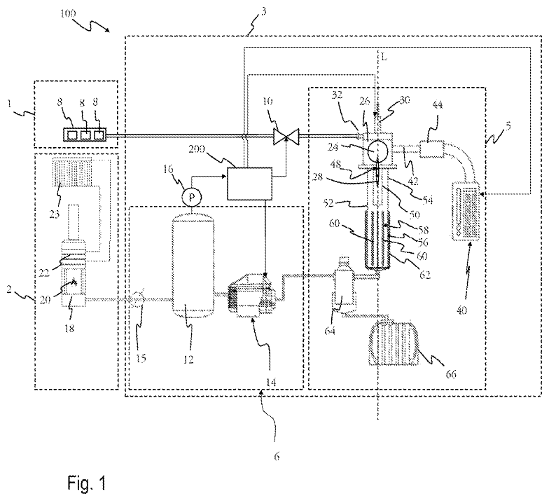

FIG. 1 is a schematic representation of a first embodiment of an energy production device implementing in particular a unit for producing dihydrogen by plasmalysis and an energy conversion unit of the heating facility type;

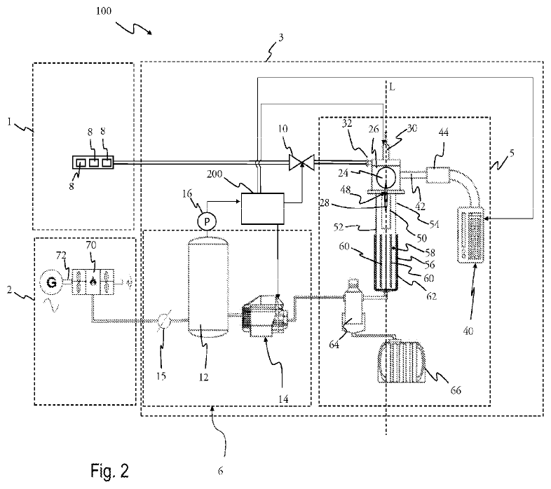

FIG. 2 is a schematic representation of a second embodiment of an energy production device which differs from FIG. 1 in that the energy conversion unit is of the gas turbine type;

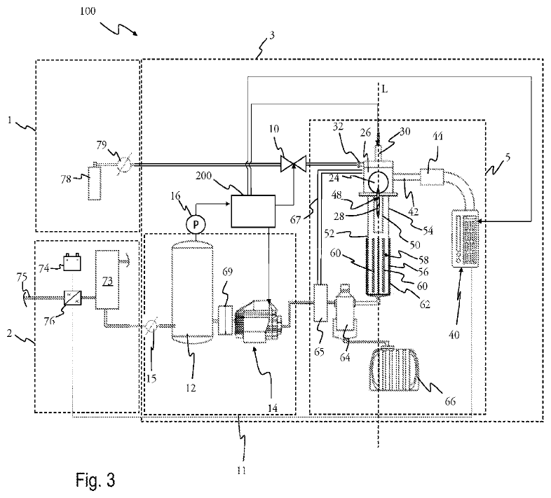

FIG. 3 is a schematic representation of a third embodiment of an energy production device which differs from FIG. 1 in that the energy conversion unit is of the fuel cell type;

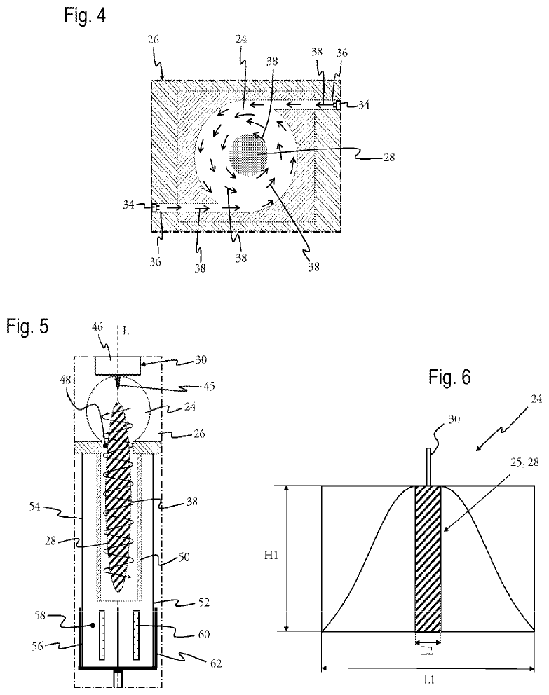

FIG. 4 is a schematic representation of a microwave radiation cavity of the dihydrogen production unit of FIG. 1, seen in a plane perpendicular to a longitudinal axis of the plasma;

FIG. 5 is a view of details of the microwave radiation cavity of FIG. 3 with a nozzle and a pipe of the dihydrogen production unit of FIG. 1, seen in a plane comprising the longitudinal axis of the plasma;

FIG. 6 is a schematic view showing dimensions of the resonant microwave radiation cavity of the plasmalysis reactor.

It should first of all be noted that while the figures set out the invention in detail for its implementation, they may of course be used to better define the invention where appropriate. It should also be noted that, in all of the figures, similar elements and/or elements fulfilling the same function are indicated by the same numbering.

FIG. 1 shows an energy production device 100 which, according to the invention, mainly comprises a device for supplying hydrocarbon gas 1, an energy conversion unit 2 and a dihydrogen production unit 3 arranged fluidically between the device for supplying hydrocarbon gas 1 and the energy conversion unit 2, the dihydrogen production unit 3 comprising at least one plasmalysis reactor 5 configured to produce at least dihydrogen from hydrocarbon gas.

According to the invention, the energy production device 100 further comprises a control module 200 configured to generate a control instruction for the dihydrogen production unit as a function of information relating to the dihydrogen present in a dihydrogen distribution area 6 fluidically arranged between the plasmalysis reactor 5 and the energy conversion unit 2.

Plasmalysis is a method that makes it possible to break down the hydrocarbon gas into solid carbon C_{(S)} and dihydrogen gas H2_{(g)} by means of a plasma generated by microwave radiation. The hydrocarbon gas can be methane CH₄, propane C₃H₈, butane C₄H₁₀ and its isomers, and/or natural gas or biomethane. Natural gas may predominantly comprise methane CH₄, and in a lesser proportion of propane C₃H₈ and/or butane C₄H₁₀ and its isomers. When the hydrocarbon gas is methane, the plasmalysis reaction is written:

$$C {H}_{4} {\to }^{Plasma} 2 {H}_{2 ( g )} + {C}_{( s )} \qquad [ Math ]$$

The plasmalysis method makes it possible to generate dihydrogen according to a completely decarbonized process, that is to say without carbon dioxide emissions, with dihydrogen gas and solid carbon forming reaction products resulting from plasmalysis.

The hydrocarbon gas required for the reaction of plasmalysis that occurs in the plasmalysis reactor 5 is supplied by the supply device 1. In the example shown, the supply device 1 comprises at least one storage device 8 which can be supplied for example by tanker trucks and/or be replaced when it is empty.

In an embodiment not shown, the hydrocarbon gas supply device is a terminal part of a gas hydrocarbon distribution network, ensuring just-in-time distribution, without a storage device. The distribution network makes it possible to convey the hydrocarbon gas from gas terminals. The distribution network is thus for example a gas distribution network for industrial, collective or household uses.

The dihydrogen production unit also comprises a controllable valve 10 arranged on this terminal part of the hydrocarbon gas distribution network, or in other words on a connection duct fluidically arranged between the device for supplying hydrocarbon gas 1 and the plasmalysis reactor 5. The controllable valve 10 is configured to receive a control instruction of the above-mentioned control unit 200, and to allow, depending on this instruction to control the arrival or non-arrival of hydrocarbon gas in the plasmalysis reactor, and where appropriate, depending on this control instruction, a larger or smaller intake of hydrocarbon gas.

The dihydrogen distribution area 6 is configured to fluidically connect an outlet of the plasmalysis reactor and an inlet of the energy conversion unit. In the example shown in FIG. 1, this dihydrogen distribution area 6 comprises a dihydrogen storage assembly sized to recover and store the dihydrogen produced by the plasmalysis reactor, before its injection into the energy conversion unit. Such a storage assembly makes it possible in particular to ensure that the dihydrogen supplied to the energy conversion unit is distributed at a suitable pressure and flow rate for the correct operation of the energy conversion unit. Here, the storage assembly comprises a storage tank 12, a compression device, or compressor, 14 upstream from the storage tank, such that the compressor is arranged fluidically between the plasmalysis reactor 5 and the storage tank 12 in order to allow the dihydrogen to be stored at an appropriate pressure in the storage tank, and an expander 15 downstream of the storage tank, so that the expander is arranged fluidically between the storage tank 12 and the energy conversion unit 2, in order to allow the energy conversion unit to be supplied with dihydrogen at an appropriate pressure.

The dihydrogen distribution area 6, and more particularly here the storage tank 12, is equipped with a measuring device allowing information relating to the presence of dihydrogen in the dihydrogen distribution area to be recorded. More particularly here, the measuring device consists of a gauge 16 able to raise the pressure of the dihydrogen present in the storage tank. The gauge 16 is connected to the control unit 200, and it is in particular based on this information relating to the presence of dihydrogen in the dihydrogen distribution area that the control unit generates a control instruction for the dihydrogen production unit, and for example a controllable valve control unit as previously mentioned.

As mentioned above, the dihydrogen production unit 3 is arranged between the device for supplying hydrocarbon gas 1 and the energy conversion unit 2 so as to convert the hydrocarbon gas from, for example, the utility gas network into dihydrogen usable as fuel for the energy conversion unit.

This energy conversion unit 2 is here a heating facility capable of converting dihydrogen into thermal energy, and more particularly here an industrial heating plant, requiring to be supplied with dihydrogen with a high flow rate. Such a need for dihydrogen supply is in particular ensured by the presence of the storage assembly in the dihydrogen distribution area 6.

The heating plant here comprises a system for controlling the injected gas 18, a flame burner 20 with a flame or catalysis suitable for the combustion of dihydrogen, a heating body 22 and a system for distributing heat 23 either by water, by air or by another heat transfer fluid.

Alternatively, an energy production device as previously mentioned could include, as an energy conversion unit, an industrial process heat source, here again requiring high-flow dihydrogen, but it could also include an individual or collective heating facility.

The plasmalysis reactor is more particularly described below with reference to FIGS. 4 to 6.

The plasmalysis reactor 5 comprises at least one microwave radiation cavity 24 formed in a block 26 made of metal. The hydrocarbon gas coming from the supply device 1 is injected into the microwave radiation cavity 24 and the microwave radiation is also guided in the microwave radiation cavity 24. The microwave radiation cavity 24 is configured to receive at least in part the plasma 28. Thus, the resonant microwave radiation cavity 24 allows very effective coupling of the microwave radiation to the plasma 28.

The microwave radiation cavity 24 can be coupled with a waveguide specific to the frequencies of between 850 MHz and 6 GHz, preferably equal to 896 MHz, 915 MHz, 922 MHz, 2.45 GHz or 5.8 GHz. It is resonant, meaning that microwave radiation is 100% reflected by at least one block wall 26 delimiting the microwave radiation cavity 24, when there is no plasma 28 present in the microwave radiation cavity 24.

As shown in FIG. 6, the dimensions of an active discharge zone 25 of the resonant microwave radiation cavity 24 are defined by the frequency used. The active discharge zone 25 is the zone where the plasma 28 forms. The width L1 of the resonant microwave radiation cavity 24 is defined by the frequency used and by the type of waveguide, the height H1 of the resonant microwave radiation cavity 24 is equal to half the width L1 of this microwave radiation cavity 24 and the width L2 of the active discharge zone 25 is less than or equal to the height H1 of the microwave radiation cavity 24. Due to the geometry of the resonant microwave cavity, the microwaves concentrate at the center of the cavity to form a distribution of the electromagnetic field with a power density sufficient to ionize the hydrocarbon gas flow. The active discharge zone 25, otherwise called the plasma zone, is the zone where the interaction between the electromagnetic field and the ionized hydrocarbon gas stream is optimal. The plasma 28 is initiated by introducing an ignition device 30 at the center of the active discharge zone 25.

The injection of the hydrocarbon gas into the microwave radiation cavity 24 is carried out by an injection device 32 of the plasmalysis reactor 5. More specifically shown in FIG. 4, the injection device 32 comprises at least one head 34, here two heads 34, coupled to at least one inlet 36 of the microwave radiation cavity 24. The head 34 makes it possible to create a hydrocarbon gas flow coming from the supply device 1.

The inlet 36 is arranged tangentially to an elongation direction of the plasma 28. The inlet 36 is also arranged tangentially to a wall delimiting the microwave radiation cavity 24. This configuration then makes it possible to create a vortex of the gas hydrocarbon stream 38 in the microwave radiation cavity 24 as is shown in FIG. 4 and in FIG. 5. The vortex contributes to the stability of the plasma 28.

The hydrocarbon gas stream 38 ionized by the microwave radiation produces the plasma 28. The gas hydrocarbon stream 38 of the vortex producing the plasma is also intended to undergo plasmalysis. It is understood in this context that the gas used to form the plasma and the gas which undergoes plasmalysis are identical. In other words, a single gas from a single source makes it possible to produce the plasma, to produce dihydrogen and solid carbon. In other words, the hydrocarbon gas serves both as plasma gas and plasmalysis reagent.

With reference to FIG. 1, the plasmalysis reactor 5 comprises a microwave radiation generator 40 which makes it possible to create a plasma in the microwave radiation cavity 24. The microwave radiation generator 40 may be a magnetron microwave radiation generator or a semiconductor microwave generator, also called a solid-state microwave radiation generator.

In an embodiment not shown, the microwave radiation generator 40 is cooled by a water and/or air cooling device. This makes it possible to keep the microwave radiation generator 40 at an optimum operating temperature.

The microwave radiation generator 40 is configured to generate microwave radiation whose power is between 0.1 kW and 100 kW at a frequency comprised between 850 MHz and 6 GHz, preferentially equal to 896 MHz, 915 MHz, 922 MHz, 2.45 GHz or 5.8 GHz.

As can be seen in particular in FIG. 1, the microwave radiation is directed toward the microwave radiation cavity 24 by a microwave transmission guide 42 coupled to the microwave radiation generator 40. The microwave transmission guide 42 is a rectangular or cylindrical waveguide or a coaxial cable.

A microwave radiation insulator 44 is arranged between the microwave radiation generator 40 and the microwave transmission guide 42, that is to say at the coupling between the microwave generator 40 and the microwave transmission guide 42. The insulator 44 prevents microwave radiation not absorbed by the plasma 28 from returning to the microwave radiation generator 40 by reflections in the microwave transmission guide 42.

As has been mentioned, the plasmalysis reactor 5 comprises a device 30 for igniting the plasma 28. The ignition device 30 is an electromechanical mechanism comprising a metal tip 45 and an actuator 46 which moves the metal tip 45 between a position outside the cavity of microwave radiation and a position in the microwave radiation cavity. The metal tip 45 is therefore retractable.

Thus, to initiate the plasma, the microwave radiation generated by the microwave radiation generator 40 is transmitted to the microwave radiation cavity 24 wherein the hydrocarbon gas is injected tangentially to the walls of the microwave radiation cavity 24 to form a vortex of a hydrocarbon gas flow. As soon as the power of the microwave radiation required is reached, the ignition of the plasma is carried out by the ignition device 30, the metal tip 45 of which remains for less than a second in the active discharge zone of the microwave radiation cavity 24. The hydrocarbon gas stream 38 itself serves to produce the plasma 28, thus undergoing the plasmalysis reaction. After the plasma priming phase, the plasma is kept and stabilized by the microwave flow and the gas hydrocarbon stream in vortex.

The pressure in the microwave radiation cavity 24 is greater than or equal to atmospheric pressure. More generally, the pressure prevailing within at least part of the dihydrogen production unit 3 is greater than or equal to atmospheric pressure. Advantageously, the pressure prevailing within at least part of the dihydrogen production unit 3 is greater than atmospheric pressure.

With reference to FIG. 1 and to FIG. 5, an outlet 48 of the microwave radiation cavity 24 is extended by a nozzle 50 composed at least in part of ceramic and/or metal. The nozzle 50 is used to contain the plasma. The nozzle 50 is also used to ensure the continuity of the plasmalysis reaction by protecting the reaction products, in particular the products derived from plasmalysis, against rapid cooling at the outlet 48 of microwave radiation cavity 24. In other words, the nozzle 50 therefore allows a gradual reduction in the temperature of the reaction products, in particular products derived from the plasmalysis at the outlet 48 of the microwave radiation cavity 24.

The plasma 28, once created, extends both in the microwave radiation cavity 24 and in the nozzle 50 along a longitudinal axis L. Thus, the nozzle extends from the outlet 48 of the microwave radiation cavity 24 in a direction opposite the microwave radiation cavity along the longitudinal axis L.

With reference to FIG. 1, the plasmalysis reactor 5 comprises a pipe 52 which extends from a vicinity of the outlet 48 of the microwave radiation cavity 24 in a direction opposite to the microwave radiation cavity 24 along the longitudinal axis L. The dimension of the pipe 52 measured along the longitudinal axis L is greater than the dimension of the nozzle 50 measured along the longitudinal axis L. The pipe completely surrounds the nozzle 50.

A first part 54 of the pipe 52 has a suitable shape, concentric to the nozzle 50. Thus, a thermal insulation chamber of the plasma 28 is delimited between an external face of the nozzle 50 and an internal face of the first part 54 of the pipe 52. The chamber makes it possible to thermally isolate the plasma 28 in order to limit, or even eliminate, temperature inhomogeneities within the plasma 28, in particular at its periphery.

The pipe 52 comprises a second part 56 which extends the first part 54 of the pipe along an axis parallel to the longitudinal axis L of the plasma 28. The second part 56 of the pipe 52 delimits a cooling chamber 58. Thus, the cooling chamber cools the reaction products. The solidification of the carbon is thus improved. Reaction products combine methane not having been decomposed during plasmalysis, the products derived from plasmalysis, that is to say dihydrogen gas and solid carbon.

In the embodiment of the invention in FIG. 1, the second part 56 of the pipe 52 comprises on its inner face a plurality of fins 60 that extend radially from the internal face of the second part 56 of the pipe 52 towards the center of the pipe and which are thermally coupled with the internal face of the second part of the pipe 52. Thus, the heat exchanges with the reaction products coming into contact with the fins 60 are improved, facilitating solidification of the carbon produced by plasmalysis.

A fluid circulation device 62 is arranged against an outer wall of the second part 56 of the pipe 52 so as to at least partially cool the second part 56 of the pipe 52. Thus, the cooling of the reaction products in the cooling chamber 58 is ensured by convective and conductive exchanges with at least a part of the internal face of the second part 56 of the pipe 52 which is cooled by the fluid circulation device 62. The separation of the dihydrogen from the other reaction products is improved by this cooling. When the pipe 52 further comprises the fins 60 which are then also cooled by thermal conduction, the separation is even more efficient. This is particularly very useful when flowing from the reaction product stream to a separation device 64 equipping the dihydrogen production unit 3.

The separation device 64 notably comprises a vortex separator element.

The separator element is configured to suck in the flow of cooled reaction products from the cooling chamber 58. The cooled solid carbon is deposited either on a bottom of the separator element, or on an inner surface of a wall of the separator element. Other solid particles are present in the flow of cooled reaction products and also are deposited at the same locations as the solid carbon.

The solid carbon thus recovered is stored in a recovery device 66 and can be supported by the same vehicle which changes or replenishes the storage devices 8 of the supply device if necessary. The solid carbon can then be recycled for various industrial uses.

The dihydrogen exiting the separation device 64 then circulates in the dihydrogen distribution area 6 fluidically arranged between the plasmalysis reactor 5 and the energy conversion unit 2.

In the first embodiment shown in FIG. 1, the dihydrogen distribution area 6 is provided with the storage assembly here comprising the storage tank 12, the compressor 14 and the expander 15, and the dihydrogen can be stored at a pressure that can range up to about 900 bars before being expanded to the appropriate pressure for the supply of the energy conversion unit 2. Thus, it is possible to meet the consumer's demand for dihydrogen in all circumstances.

As mentioned above, the control module 200 of the energy production device is configured according to the invention to generate a control instruction for the dihydrogen production unit as a function of a piece of information relating to the dihydrogen present in a dihydrogen distribution area fluidically arranged between the plasmalysis reactor and the energy conversion unit.

More particularly, in the shown example, the control module 200 retrieves information and is able to generate one or more control instructions to different components of the dihydrogen production unit, among them the controllable valve 10, the ignition device 30 of the plasmalysis reactor 5, the microwave radiation generator 40, and the compressor 14.

In an independent manner, by only performing a specific control instruction, or in complementary fashion, by performing several control instructions simultaneously, the control module 200 can control the supply of hydrocarbon gas by controlling the operation of the controllable valve 10, or control the operation of the plasmalysis reactor by controlling the microwave radiation device 40 and/or by controlling the ignition device 30, or control the operation of the storage assembly by controlling the compressor 14.

These control instructions may consist of a binary operation instruction, of the start-and-stop type, or consist of an operation instruction adjusted, with a production of dihydrogen of variable quantity and adjusted to demand.

It is understood that the presence of this control module makes it possible to operate the dihydrogen production unit as a function of the need for the energy conversion unit, in order to adjust the energy consumption of the device without reducing the service of the energy conversion unit.

A first example of a method of operating the energy production device can be as follows. Energy demand, here thermal, is formed at the energy conversion unit. The result is a drawdown of dihydrogen, and the volume of dihydrogen present in the storage vessel 12 is reduced. The dihydrogen production unit remains off, in a shutdown mode that is not energy-consuming, until the pressure of the dihydrogen present in the storage tank 12, measured by the gauge 16, has a value greater than a predefined threshold value, for example on the order of 10 bars. As soon as the pressure of the dihydrogen becomes less than this predefined threshold value, the control module transmits activation information to one of the components likely to be driven by the control module. By way of example, simultaneously, the controllable valve 10 is opened to allow the passage of hydrocarbon gas, while the ignition device 30 and the microwave radiation generator 40 are actuated. Here, it is in the binary operating mode mentioned above. A control instruction corresponding to the closing or placing of these components on standby is subsequently generated by the control module when the storage tank is again filled with dihydrogen.

A second example of a method of operating the energy production device can be as follows. Once again, energy demand, here thermal, is formed at the energy conversion unit. The result is a drawdown of dihydrogen, and the volume of dihydrogen present in the storage vessel 12 is reduced. The dihydrogen production unit is then controlled to operate initially in a first mode, corresponding to a reduced production mode of dihydrogen, for example by reducing the gas inlet flow rate by limiting the opening of the controllable valve 10 and limiting the amount of microwave radiation in the plasmalysis reactor by a reduced load operation of the microwave radiation generator. This first reduced dihydrogen production mode is implemented as long as the pressure of the dihydrogen present in the storage tank 12, measured by the gauge 16, has a value greater than a predefined threshold value, for example on the order of 10 bars. As soon as the pressure of the dihydrogen becomes less than this predefined threshold value, the control module modifies the control instructions to modulate the operation of the dihydrogen production unit and to operate it at full speed. Here, it is in the modular operating mode mentioned above.

A second embodiment is shown in FIG. 2 and differs from what has been described for the first embodiment in that the energy conversion unit 2 comprises a gas turbine.

Downstream of the expander 15, a dihydrogen combustion chamber 70 makes it possible to create sufficient energy to drive a motor shaft 72 and an associated electric generator, and thus to convert the energy of the dihydrogen into mechanical or electrical energy.

Alternatively, provision may be made for the energy conversion unit to be an internal combustion engine, it being understood that the structure of the dihydrogen production unit remains the same as that which has just been described in this third embodiment, here also with a dihydrogen distribution area 6 which comprises a compressor, a storage tank and an expander.

The operation of the gas turbine, or of the internal combustion engine, involves supplying a high-speed dihydrogen so that the dihydrogen production unit is in accordance with the first embodiment equipped with a compressor and a storage tank making it possible to store the dihydrogen produced up to a pressure of 900 bars.

A third embodiment is shown in FIG. 3 and differs from what has been described for the first embodiment in that the energy conversion unit 2 here comprises a fuel cell 73. As schematically shown, the fuel cell receives dihydrogen and air at the inlet, and is configured to deliver electricity to electrical equipment and/or an electrical network 75. By way of non-limiting examples shown in FIG. 3, the electrical equipment downstream of the fuel cell is the microwave radiation generator 40, in order to allow an autonomous power supply thereof, and an electrical energy storage member 74. Here, an appropriate current converter 76 is arranged between the output of the fuel cell 73 and the electrical equipment and network.

The proper operation of the fuel cell requires a greater level of purity of the dihydrogen than was necessary for the other types of energy conversion units previously described such as boilers for example. In this context, the energy production device according to this third embodiment is equipped with filtration means.

As shown in FIG. 3, the energy production device according to this third embodiment can in particular be equipped with a filtration device 65 arranged exiting the plasmalysis reactor. The gases collected exiting the plasmalysis reactor 5, and in particular after being passed through the separation device 64, pass into a filter of this filtration device which is configured to separate the dihydrogen from the other gaseous products, which may in particular be, as shown in FIG. 3, reinjected into the reactor for a new plasmalysis, via a return line 67. The dihydrogen collected exiting the filtration device 65 is directed toward the dihydrogen distribution area 6 and more particularly here to the compressor 14 before being stored in the storage tank 12.

In other words, a filtration is carried out downstream of the plasmalysis reactor which tends to distinguish, within the plasmalysis reaction products, the dihydrogen capable of being directed toward the fuel cell and the other residual gases, in minuscule quantities. These residual gases may for example be methane which has not undergone total decarbonization and any secondary reaction products of ethane, ethylene, etc. All the residual gases are reinjected into the plasmalysis reactor to break them down completely.

Furthermore, the energy production device according to the third embodiment, that is to say with an energy conversion unit comprising a fuel cell, can in particular be equipped with a dihydrogen filtering member 69 which is configured to increase the purity of the dihydrogen passing through this dihydrogen filtering member 69. In this way, it is intended to obtain a dihydrogen purity level compatible with the operation of a fuel cell 73.

As shown in FIG. 3, the dihydrogen filtering member 69 is arranged fluidically between the compression device 14 and the storage tank 12.

It should be noted that if the filtration means, that is to say the filtration device 65 and the filtration member 69, are shown only in the third embodiment, they could, without departing from the context of the invention, equip a production device according to other embodiments of the invention previously described, even if such device implements dihydrogen burners, and/or a turbine and/or an internal combustion engine within the energy conversion units, and thus a degree of purity of the dihydrogen arriving in these energy conversion units is not essential.

Furthermore, the device according to the third embodiment differs here from the foregoing in that a storage cylinder 78 and an associated expander 79 participate in forming the supply device 1. It should be noted that this embodiment of the supply device could be different and be replaced by the embodiments described previously, and that more generally, any one the embodiments described could be implemented in each embodiment without departing from the context of the invention.

Of course, the invention is not limited to the examples that have just been described, and numerous modifications can be made to these examples without departing from the scope of the invention.

By way of non-limiting example, a filtration system could be provided upstream from the plasmalysis reactor, that is to say between the supply device and the plasmalysis reactor, which in particular makes it possible to purify the hydrocarbon gas intended to be injected into the microwave radiation cavity in order to improve the performance of plasmalysis. In particular, when the inlet gas is natural gas coming from a gas network composed mainly of methane, filtering unwanted components such as nitrogen, carbon monoxide or carbon dioxide can thus be carried out before injection into the reactor with plasmalysis.

The invention, as has just been described, clearly achieves the goal that it was set, and makes it possible to propose an energy production device, whether thermal, electrical or mechanical, which is configured to use a supply of hydrocarbon gas, which may in particular consist of a city gas network and dihydrogen burners, which are more ecological, owing to the presence of a dihydrogen production unit by plasmalysis combined with a control module capable of controlling the operation of this production unit in order to efficiently, but economically, meet demand for energy production.

1. An energy production device, comprising:
hydrocarbon gas supply device configured for supplying hydrocarbon;
an energy conversion unit;
a dihydrogen production unit fluidically arranged between the hydrocarbon gas supply device and the energy conversion unit, the energy conversion unit being configured to convert energy supplied by H₂ into electrical, thermal, and/or mechanical energy;
a microwave plasma plasmalysis reactor configured to generate a plasmalysis of the hydrocarbon gas so as to produce at least dihydrogen directed to the energy conversion unit, the dihydrogen production unit further comprising a separation device, configured to separate the dihydrogen and the solid carbon;
a control module configured to generate a control instruction for the dihydrogen production unit as a function of information relating to H₂ present in a dihydrogen distribution area fluidically arranged between the plasmalysis reactor and the energy conversion unit,
wherein the dihydrogen distribution area comprises a storage assembly arranged at an outlet of the plasmalysis reactor and hydraulically connected to the plasmalysis reactor and the energy conversion unit, the storage assembly comprising a compression device, a storage tank, and an expander, the compression device being positioned to transfer H₂, exiting the plasmalysis reactor, into the storage tank, and
wherein the H₂ exiting the separation device equipping the dihydrogen production unit then circulates in the dihydrogen distribution area fluidically arranged between the plasmalysis reactor and the energy conversion unit.

2. The energy production device of claim 1, wherein the control instruction of the dihydrogen production unit comprises a control instruction for the hydrocarbon gas intake via the supply device and/or for the plasmalysis reactor.

3. The energy production device of claim 1, wherein the plasmalysis reactor comprises microwave radiation generator, a microwave transmission guide configured to guide microwave radiation from the microwave radiation generator to a microwave radiation cavity of the plasmalysis reactor.

4. The energy production device of claim 3, wherein the control instruction for the plasmalysis reactor comprises a control instruction for the microwave radiation generator.

5. The energy production device of claim 3, wherein the plasmalysis reactor comprises a plasma ignition device comprising a retractable metal tip configured to be inserted or retracted in the microwave radiation cavity using an actuator.

6. The energy production device of claim 5, wherein the control instruction for the plasmalysis reactor comprises a control instruction for the ignition device.

7. The energy production device of claim 3, wherein the microwave radiation generator is a solid-state generator or a magnetron.

8. The energy production device of claim 1, wherein the control instruction of the dihydrogen production unit comprises an instruction for controlling the compression device.

9. The energy production device of claim 1, wherein the information relating to the H₂ present in a dihydrogen distribution area from which the control module is configured to control the operation of the dihydrogen production unit is information relating to the H₂ present in the storage assembly.

10. The energy production device of claim 9, wherein the information relating to the H₂ present in the dihydrogen distribution area is obtained via a pressure gauge, and
wherein the control module is configured to generate and transmit a control instruction to the dihydrogen production unit when a pressure measured by the gauge is below a threshold value.

11. The energy production device of claim 1, wherein a filtration system is arranged upstream of the plasmalysis reactor.

12. The energy production device of claim 1, wherein a filtration device is arranged downstream of the plasmalysis reactor, and
wherein the filtration device is configured to separate the H₂ from other residual gases.

13. The energy production device of claim 12, further comprising:
a return pipe that extends between the filtration device and the plasmalysis reactor, configured to reinject residual gases collected in the filtration device into the reactor.

14. The energy production device according of claim 1, wherein the energy conversion unit is a domestic, collective or industrial heating facility or an industrial process heat source.

15. The energy production device of claim 1, wherein the energy conversion unit comprises a gas turbine or an internal combustion engine, mechanically coupled to an electric generator.

16. The energy production device of claim 1, wherein the energy conversion unit comprises a fuel cell.

17. The energy production device of claim 16, comprising a dihydrogen filtration member arranged fluidically between the compression device (14) and the storage tank (12), and
wherein the dihydrogen filtration member is configured to guarantee a purity of the H₂ compatible with operation of a fuel cell.

18. A method for operating the energy production device of claim 1, comprising:
controlling the dihydrogen production unit by the control module by modulating production of H₂ by operating the energy conversion unit.

19. The method of claim 18, wherein the modulating is carried out in binary mode, and
wherein the plasmalysis reactor is started only when the information relating to the H₂ present in the dihydrogen distribution area has an outgoing value from a predefined value range.

20. The method of claim 19, wherein the modulating comprises adjusting (i) a flow rate and/or pressure of the hydrocarbon gas entering the dihydrogen production unit and/or (ii) operating power of the dihydrogen production unit.
